(19) United States
(12) Patent Application Publication
(10) Pub. No.: US 2008/0136657 A1
(43) Pub. Date: Jun. 12, 2008

(54) AUTOMATED TELLER MACHINE

(76) Inventors: Barrie Clark, Dundee (GB); Stuart W. Masterton, Newtyle (GB); Scott L. Colston, Dundee (GB); Gary A. Ross, Edinburgh (GB)

Correspondence Address: Michael Chan;Intellectual Property Section, Law Department, NCR Corporation, 1700 South Patterson Blvd., Dayton, OH, 45479-0001, US

(21) Appl. No.: 11/608,457

(22) Filed: Dec. 8, 2006

(51) Int. Cl. G08B 21/00

(52) U.S. Cl. 340/686.6

(57) ABSTRACT

Automated Teller Machine comprises a fascia having a cash dispensing aperture, a sensor arranged to detect the presence of an object outside of the aperture and the distance to the object; and a processor. The processor is arranged to determine, from the output of the detector, whether the distance to the object is within a predetermined maximum and whether the object is moving or stationary and to output a signal dependent thereon.

### BACKGROUND OF THE INVENTION

The present invention relates to an Automated Teller Machine (ATM) including a fraud detection device and in particular to a fraud detection device arranged to detect “cash trapping” devices.

An ATM has a user console to allow a customer to operate the machine and a cash dispensing mechanism. The cash dispensing mechanism typically includes at least one bill picking mechanism for extracting bills one by one from an associated currency cassette and a presenting mechanism for presenting a bundle of said bills to a user via a dispensing slot in the ATM. Such a dispenser is known as a bunch dispenser.

The dispensing mechanism of an ATM can also be of a type that delivers bills to a user one by one in a non-bundled manner, known as a spray dispenser.

The detector of the present invention is intended to combat the practice of ‘cash-trapping’ whereby a dummy fascia, sometimes known as a “quasi overlay”, is placed over the cash-exit area of the ATM and the user is fooled into believing that cash has not been dispensed when it has actually been dispensed behind the dummy fascia, hidden from the user's view. The criminal who attached the dummy fascia can then remove it and retrieve some, or all, of the dispensed cash by various means which will not be detailed further here for security reasons. It is sufficient to say that this is a significant security problem in the ATM business.

These devices can be sophisticated or can be as simple as a plate with double sided tape attached. All cash trapping methods have in common the fact that they block the area between the cash slot and the customer.

There have been a number of different approaches to this problem in the past from the use of capacitive sensing to detect attachments to the fascia to visual monitoring of the surface of the fascia to detect differences in the appearance of the fascia due to the attachment of a dummy fascia.

### SUMMARY OF THE INVENTION

It is an object of the present invention to provide an ATM and method of operation thereof which addresses the problem detailed above.

One theoretical method of detecting such a device would be to use an optical beam which would be reflected back if a cash trapping device was present. A coaxial fiber optic cable can be used with the inner core as the transmitting layer and the outer core at the receiving layer. However, consideration must be given to ensure non fraudulent objects, such as human hands or passing pedestrians, are not detected by the system.

Also, the light reflected from an object is dependent on the reflectivity of that object. For example, more light may be reflected from a more distant white object than is reflected from a closer black object. Therefore, in a worst case scenario more light may be reflected, for a given incident light intensity, from an ATM user's white shirt than is reflected from a black quasi overlay. These problems amongst others make the use of optical sensing for the detection of quasi overlays extremely problematical.

According to a first aspect of the present invention there is provided an Automated Teller Machine comprising a fascia having a cash dispensing aperture; a sensor arranged to detect the presence of an object outside of the aperture and the distance to the object; and a processor arranged to determine, from the output of the sensor, whether the distance to the object is within a predetermined maximum and whether the object is moving or stationary and to output a signal dependent thereon.

Preferably the processor is arranged to output a signal instructing the Automated Teller Machine to enter an alarm condition when the object is both stationary and within said maximum distance. Most preferably the maximum distance is 100 mm from the aperture.

The Automated Teller Machine of claim 2, wherein the Automated Teller Machine is arranged to cease dispensing cash during said alarm condition.

In one embodiment the Automated Teller Machine is arranged to present an explanatory screen to the user on a user interface display during said alarm condition.

In addition the Automated Teller Machine may be arranged to periodically test for the continued presence of the detected object, during said alarm condition, and if the object is not found is arranged to cancel the alarm and return the Automated Teller Machine to normal operation.

Further during said alarm condition, the Automated Teller Machine may be arranged to dispenses cash to a user once in order to assist in the determination as to whether or not the alarm condition is an error caused by the user's hand being placed adjacent and in front of the dispenser aperture during a dispense operation.

Preferably the sensor is an ultrasonic sensor most preferably a Sanwa SCS401T and SCS401R transmitter/receiver pair. Alternatively, the sensor may be an optical sensor, most preferably a SUNX CX444 (with analogue output). In either embodiment, preferably, the sensor is located within the body of the ATM.

According to a second aspect of the present invention there is provided a method of detecting a cash trapping device in the form of a dummy fascia on an Automated Teller Machine comprising a fascia having a cash dispensing aperture; a sensor arranged to detect the presence of an object outside of the aperture and the distance to the object; and a processor, the method comprising determining, from the output of the detector, whether the distance to the object is within a predetermined maximum and whether the object is moving or stationary and to output a signal dependent thereon.

The above and other objects, features, and advantages of the present invention will become apparent from the following description and the attached drawings.

### BRIEF DESCRIPTION OF THE DRAWINGS

FIG. 1 is a perspective view of an in-lobby ATM in accordance with the invention;

FIG. 2 is a block diagram representation of the ATM of FIG. 1;

FIG. 3 is a schematic representation of the cash dispensing mechanism of the ATM of FIG. 1;

FIG. 4a is a schematic representation of an area of the fascia of the ATM of FIG. 1 adjacent the dispenser slot in more detail;

FIG. 4b is a schematic representation of the area of the fascia of FIG. 4a with a dummy fascia attached;

FIG. 5a is a schematic representation of the interior of the ATM of FIG. 1 adjacent the dispenser slot with an ultrasonic emitter and detector arranged in accordance with the present invention;

FIG. 5b is a schematic representation of the interior of the ATM of FIG. 1 adjacent the dispenser slot with a unitary optical sensor arranged in accordance with the present invention; and

FIG. 6 is a flow diagram of a method of detection of a dummy fascia in accordance with the present invention during cash dispensing.

### DETAILED DESCRIPTION

The normal operation of an ATM during a pick operation will be described, for completeness, before the invention is described in detail.

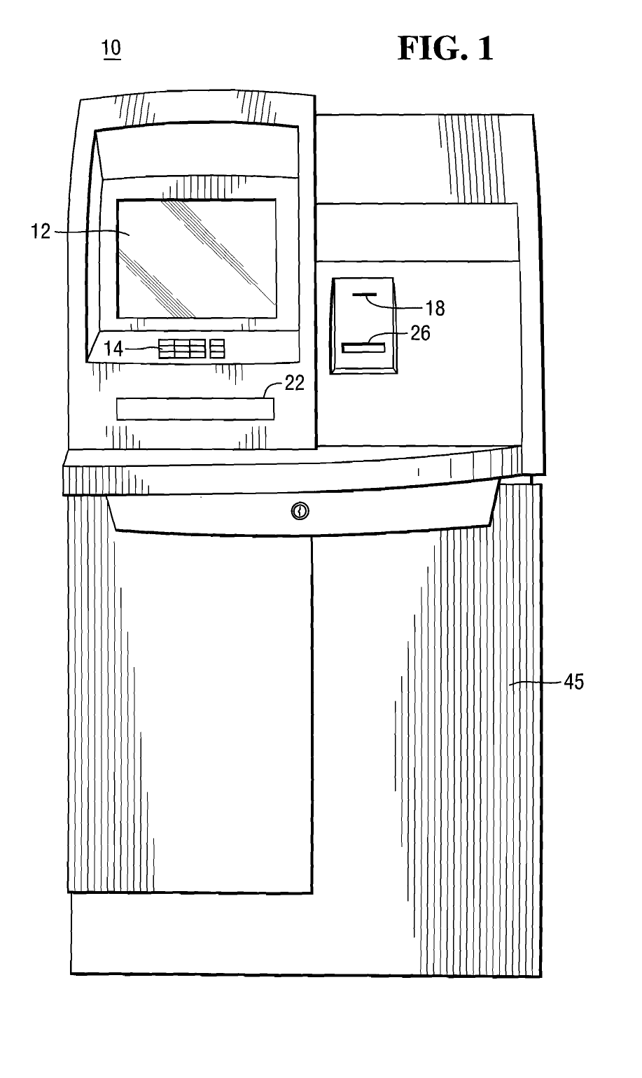

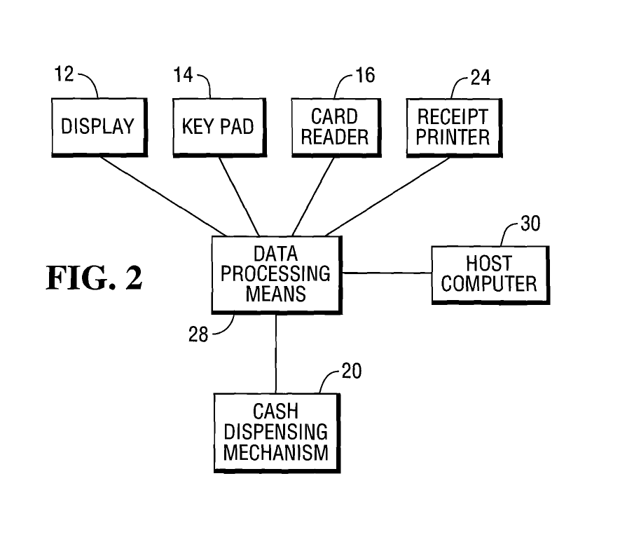

Referring first to FIGS. 1 and 2, an ATM 10 comprises a display 12 for displaying user information, a key pad 14 for inputting data, a card reader 16 for receiving a user identity card via a card slot 18, a cash dispensing mechanism 20 for dispensing currency bills stored in the mechanism 20 to a user during a transaction via a slot 22, a receipt printer 24 for printing a receipt acknowledging a transaction made by a user and for issuing the receipt to 20 the user via a slot 26, and data processing means 28 to which the display 12, the key pad 14, the card reader 16, the cash dispensing mechanism 20 and the receipt printer 24 are connected.

To make a withdrawal, a user inserts his or her identification card in the card slot 18 of the ATM 10. Data contained in a magnetic strip on the card is read by the card reader 16 25 and transmitted by the data processing means 28 to a host computer 30. The user identifies himself or herself by entering his or her personal identity number via the key pad 14. If the host computer 30 authorizes the card then the user can proceed with his withdrawal by first entering details of the transaction, e.g. the amount of the withdrawal by means of the key pad 14.

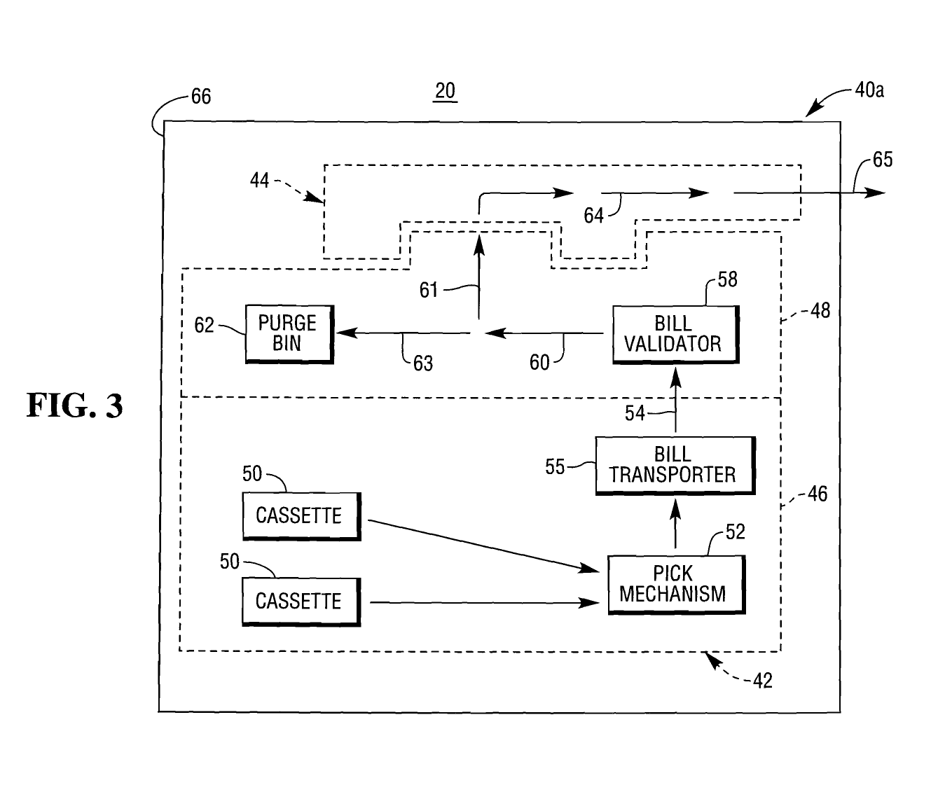

Referring now to FIG. 3, a cash dispensing mechanism 20 having a rear loading configuration is shown. Other configurations are available and this representation is not limiting. The cash dispensing mechanism 20 comprises a safe 40a inside which are housed a lower unit 42 and an upper unit 44. The safe 40a is mounted in a housing 45 (see FIG. 1) of the ATM 10. The lower unit 42 has lower and upper sections 46,48. Inside the lower section 46 of the lower unit 42 are mounted currency cassettes 50 which are associated with a conventional pick mechanism 52. It should be understood that the upper unit 44 is mounted on the lower unit 42 with a selected orientation relative to the lower unit 42 determined by the fact that the cash dispensing mechanism 20 has a rear loading configuration.

When a request for a cash withdrawal is made and approved, the data processing means 28 (see FIG. 2) causes the pick mechanism 52 to pick bills in a known manner from at least one cassette 50. Each bill is picked singly and the bills are individually passed along a feed path (indicated by arrow 54) by conventional bill transport means 55 included in the lower section 46. The feed path takes the bill from the lower section 46 to a conventional bill validator 58 in the upper section 48. If the bill validator 58 accepts the bill then the bill is first transported along a horizontal feed path 60 and is then transported vertically out of the lower unit 42 and into the upper unit 44 along a feed path 61. If the validator 58 does not accept the bill (e.g. if the bill is a multiple bill) then the bill is rejected and directed into a purge bin 62 via a horizontal feed path 63 which is a continuation of the feed path 60. The bills transported vertically out of the lower unit 42 are transported through the upper unit 44 via a feed path 64 where the bills are delivered to the user via a slot 65 in the safe 40a and via the cash dispensing slot 22 (see FIG. 1) in the housing of the ATM 10. As mentioned above, depending on the configuration of the upper unit 44, the bills are either stacked and delivered to the user as a bunch, or are delivered to the user one by one into a spray tray. Only the first example will be further described herein, however, the invention is equally applicable to both embodiments.

FIGS. 1 to 3 illustrate a bunch dispenser, with a slot and shutter which are visible to a user. However, the method and apparatus will operate as well with a spray dispenser in which the dispensing aperture is not visible to the user and may therefore not have a protective shutter. The term “aperture” is used therefore to describe the slot through which either a bunch or spray dispenser dispenses cash.

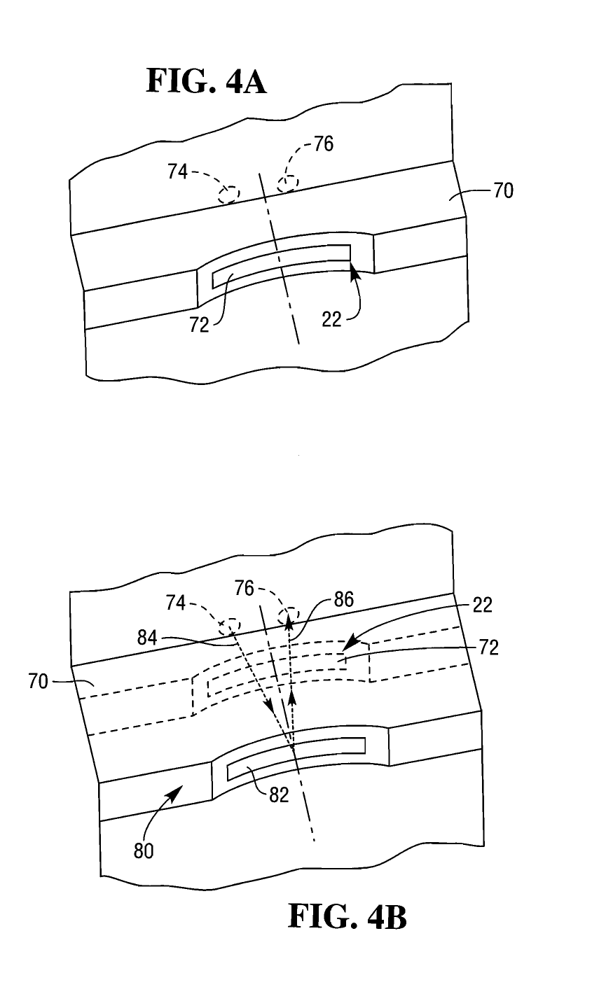

FIGS. 4a illustrates a portion of the fascia 70 of the ATM around the cash dispensing slot 22 and detailing the movable shutter 72 which is opened to dispense cash to a user. The sensor may be formed from an emitter 74 and detector 76, as illustrated in hatched lines as they are located within the ATM 10. For example an ultrasonic transmitter and receiver such as Sanwa SCS401T and SCS401R would be suitable. Alternatively, an optical sensor could be used such as a photoelectric reflective displacement sensor such as SUNX CX444 (with analogue output).

FIG. 4b illustrates the area of the fascia 70 of the ATM of FIG. 4a covered with a removable dummy fascia 80. The shutter 82 in the dummy fascia 80 is not movable and as such the user can not access money dispensed from the ATM behind the dummy fascia 80. The path of a signal emitted from the emitter 74, reflected off of the dummy fascia 80 and reflected into the detector 76 is illustrated by rays 84 and 86 respectively.

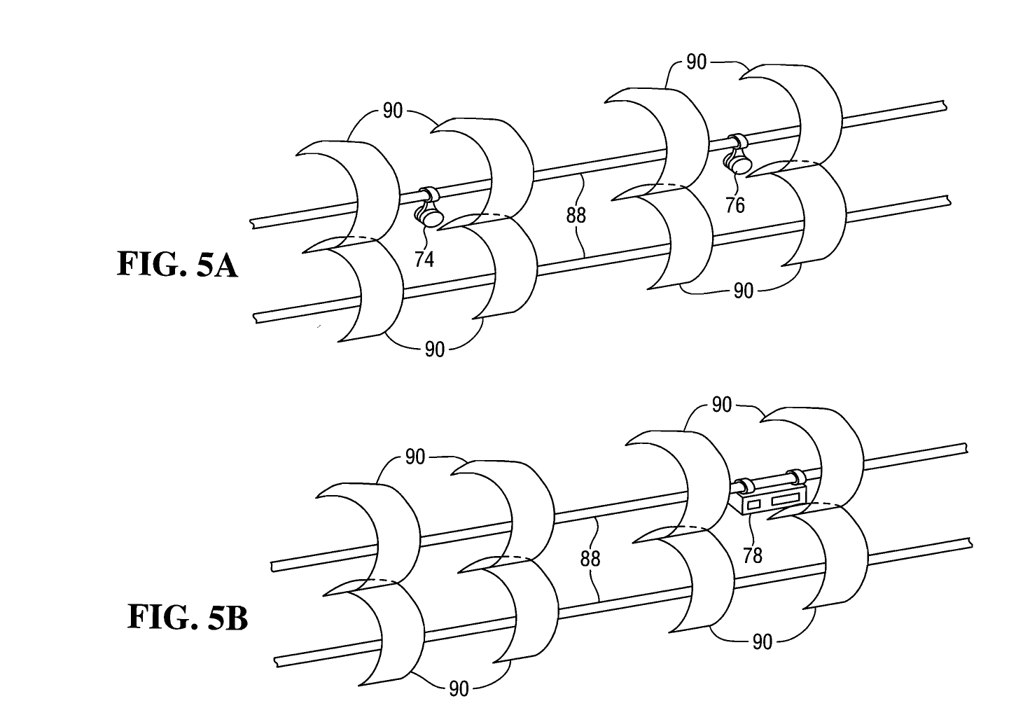

FIG. 5a illustrates in more detail the attachment of the ultrasonic emitter 74 and detector 76 to the support rods 88 of the presenter belts 90 of the ATM dispenser mechanism of the ATM of FIG. 1. FIG. 5b illustrates the attachment of the combined optical emitter and detector 78 on the same support rod 88.

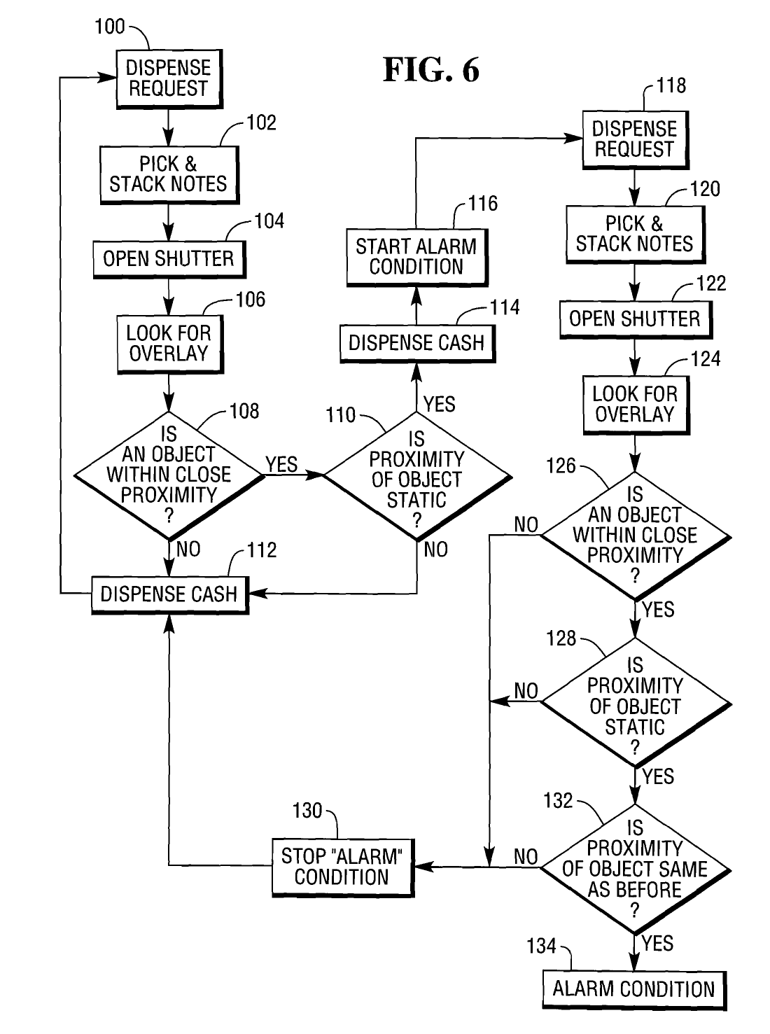

FIG. 6 is a flow diagram illustrating the operation of an Automated Teller Machine 10 in order to detect a dummy fascia attached thereto whilst dispensing cash to a user.

The dispensing process begins with a receipt of a standard request, from a user, to dispense cash (box 100). In response to this request, the ATM 10 picks and stacks notes (box 102) and opens the shutter 72 on the dispenser slot 22 (box 104) in the usual manner. Thereupon the ATM looks for an overlay (box 106). This includes the ATM processor 28 causing the emitter 74 to emit a signal and the detector 76 to look for a response which indicates the presence of an object in front of the shutter 72. If an object is detected the processor determines whether or not the object is within a predetermined distance, of 100 mm, from the shutter 72 (box 108). This is achieved because the detector is capable of determining the distance to the object. Thereafter the processor determines if the object is moving or stationary, through repeated measurements over a predetermined time period (box 110). These steps can be carried out in either order. If it is determined that the object is either not within the predetermined maximum distance or is not stationary then the ATM dispenses the picked cash in the normal manner (box 112). However if the object is determined to be both within the predetermined maximum distance and stationary then, in this embodiment, the ATM dispenses case (box 114) but also enters an alarm condition (box 116). The result of this alarm condition may vary from ATM to ATM. In this embodiment the condition results in the ATM temporarily suspending cash dispensing services. Also, the ATM may present a warning screen on the display 12 to inform user's of the possible problem and to announce the suspension of the cash dispensing facility. The ATM service providers may include other steps such as suspending all ATM services. Also, the ATM may inform either the service provider's control centre or the police of the possible problem.

The reason for the cash dispense (box 114) when there appears to be a false fascia in front of the ATM 10 is to ensure that a user is not prevented from receiving cash due to a false reading caused, for example, because of the user holding their hand in front of the slot 22 awaiting his or her cash. If a subsequent request for cash is received (box 118) the ATM picks and stacks notes (box 120), opens the shutter 72 (box 122) and looks for an overlay (box 124) as with the first request described above. The process then again determines if any detected object is within a predetermined maximum distance (box 126) and whether or not that object is static (box 128). If the answer to either of those questions is no then the alert is cancelled (box 130) and cash is dispensed as normal (box 112). However, if the answer to both of those questions is yes then the processor determines if the distance to the object on this subsequent request is the same as that on the prior request (box 132). If the distance to the object has not changed then the alarm condition is maintained (box 134) and cash is not dispensed to a user as a result of this request. One or more of the optional actions, such as informing the police, may be taken in response to this second detection as the likelihood of the object being an overlay is significantly increased if it has not moved between requests.

In another embodiment the processor 28 can be arranged to open the shutter and detect the present once an object, the distance of that object and whether or not that distance is static, as described above, as a test process instead of awaiting the receipt of a dispense request to instigate the process. If a static body is located within the predetermined maximum distance, as described above, during the test process the ATM can again be placed in an alarm condition as described above.

As detailed above one problem addressed by the ATM in accordance with the present invention is the refining of the apparatus and method so as to detect a dummy fascia whilst not detecting a person using the ATM and mistaking that person for a dummy fascia. This is achieved by limiting the system to detect objects within a short range outside the real fascia 70, less than 100 mm from the dispenser slot 22, where any detected object is statistically more likely to be a quasi overlay than a user.

From the above description of the invention, those skilled in the art to which the present invention relates will perceive improvements, changes and modifications. Numerous substitutions and modifications can be undertaken without departing from the true spirit and scope of the invention. Such improvements, changes and modifications within the skill of the art to which the present invention relates are intended to be covered by the appended claims. For example, the maximum distance of 100 mm from the shutter 72 to the object has been selected as a false fascia attached to a fascia 70 which extends beyond that distance is likely to be apparent to a user. However, modifications to that distance can be made by a person skilled in the art to detect specific false fascia on specific ATM designs, as appropriate.

What is claimed is:

1. An Automated Teller Machine comprising:
a) a fascia having a cash dispensing aperture;
b) a sensor arranged to detect the presence of an object outside of the aperture and the distance to the object; and
c) a processor arranged to determine, from the output of the detector, whether the distance to the object is within a predetermined maximum and whether the object is moving or stationary and to output a signal dependent thereon.

2. The Automated Teller Machine of claim 1, wherein the processor is arranged to output a signal instructing the Automated Teller Machine to enter an alarm condition when the object is both stationary and within said maximum distance.

3. The Automated Teller Machine of claim 1, wherein said maximum distance is 100 mm from the aperture.

4. The Automated Teller Machine of claim 2, wherein the Automated Teller Machine is arranged to cease dispensing cash during said alarm condition.

5. The Automated Teller Machine of claim 2, wherein the Automated Teller Machine is arranged to present an explanatory screen to the user on a user interface display during said alarm condition.

6. The Automated Teller Machine of claim 2, wherein the Automated Teller Machine is arranged to periodically test for the continued presence of the detected object, during said alarm condition, and if the object is not found is arranged to cancel the alarm and return the Automated Teller Machine to normal operation.

7. The Automated Teller Machine of claim 2, wherein during said alarm condition the Automated Teller Machine is arranged to dispense cash to a user once in order to assist in the determination as to whether or not the alarm condition is an error caused by the user's hand being placed adjacent and in front of the dispenser aperture during a dispense operation.

8. The Automated Teller Machine of claim 1, wherein the sensor is an ultrasonic sensor.

9. The Automated Teller Machine of claim 8, wherein the ultrasonic sensor is a Sanwa SCS401T and SCS401R transmitter/receiver pair.

10. The Automated Teller Machine of claim 1 wherein the sensor is an optical sensor

11. The Automated Teller Machine of claim 10, wherein the optical sensor is a SUNX CX444 (with analogue output).

12. The Automated Teller Machine of claim 1, wherein the sensor is located within the body of the ATM.

13. A method of detecting a cash trapping device in the form of a dummy fascia on an Automated Teller Machine comprising:
a) a fascia having a cash dispensing aperture;
b) a sensor arranged to detect the presence of an object outside of the aperture and the distance to the object; and
c) a processor
the method comprising determining, from the output of the detector, whether the distance to the object is within a predetermined maximum and whether the object is moving or stationary and to output a signal dependent thereon.

14. The method of claim 13, wherein the processor outputs a signal instructing the Automated Teller Machine to enter an alarm condition when the object is both stationary and within said maximum distance.

15. The method of claim 1, wherein said maximum distance is 100 mm from the aperture.

16. The method of claim 14, wherein said alarm condition causes the Automated Teller Machine to cease dispensing cash.

17. The method of claim 14, wherein said alarm condition causes the Automated Teller Machine to present an explanatory screen to the user on a user interface display.

18. The method of claim 14, wherein said alarm condition causes the Automated Teller Machine to periodically test for the continued presence of the detected object and if the object is not found causes the alarm condition to be cancelled and the Automated Teller Machine operation to revert to normal.

19. The method of claim 14, wherein during said alarm condition the Automated Teller Machine dispenses cash to a user once in order to assist in the determination as to whether or not the alarm condition is an error caused by the user's hand being placed adjacent and in front of the dispenser aperture during a dispense operation.
